(19) United States
(12) Patent Application Publication
(10) Pub. No.: US 2010/0290368 A1
(43) Pub. Date: Nov. 18, 2010

(54) HALF-DUPLEX RFID TRANSPONDER AND A METHOD OF OPERATING A HALF-DUPLEX RFID TRANSPONDER

(75) Inventors: Herbert Meier, Moosburg (DE); Andreas Hagl, Dachau (DE); Christian Keller, Moosinning (DE)

Correspondence Address: TEXAS INSTRUMENTS INCORPORATED, P O BOX 655474, M/S 3999, DALLAS, TX, 75265, US

(73) Assignee: Texas Instruments Deutschland GmbH, Freising (DE)

(21) Appl. No.: 12/772,718

(22) Filed: May 3, 2010

(30) Foreign Application Priority Data
May 14, 2009 (DE) 10 2009 021 329.5

(51) Int. Cl. H04B 7/005

(52) U.S. Cl. 370/278

(57) ABSTRACT

A half-duplex RFID transponder with an integrated three-dimensional front-end circuit which includes three LC resonant circuits arranged in a three-dimensional configuration. Each LC resonant circuit is coupled to a different one of three storage capacitors which are charged during a capacitor charging phase by energy in an RF signal received by the associated LC resonant circuit. The front-end circuit includes three receiver channels and each receiver channel is associated to a different one of the three LC resonant circuits. A channel selector is adapted to detect, which one of the three storage capacitors is first charged to a threshold voltage, to select the receiver channel associated to the LC resonant circuit which is coupled to the storage capacitor which is first charged and to deactivate the two other receiver channels. A method of operating a half-duplex RFID transponder with three LC resonant circuits arranged in a three-dimensional configuration with each LC resonant circuit coupled to a different storage capacitor which is charged during a capacitor charging phase by energy in an RF signal received by the associated LC resonant circuit. Three receiver channels are associated to the three LC resonant circuits. The method includes monitoring the charge level of each of the three storage capacitors, detecting which storage capacitor is first charged to a threshold voltage, selecting the receiver channel associated to the first charged storage capacitor and deactivating the two other receiver channels.

### CROSS-REFERENCE TO RELATED APPLICATIONS

This patent application claims priority from German Patent Application No. 10 2009 021 329.5, filed May 14, 2009, which is incorporated herein by reference in its entirety.

### FIELD OF THE INVENTION

The invention generally relates to a half-duplex RFID transponder with an integrated three-dimensional front-end circuit. The RFID transponder comprises three LC resonant circuits arranged in a three-dimensional configuration and each LC resonant circuit is coupled to a different one of three-storage capacitors which are charged during a capacitor charging phase by energy comprised in an RF signal which is received by the associated LC resonant circuit. The invention further relates to a method of operating a half-duplex RFID transponder.

### BACKGROUND OF THE INVENTION

RFID systems including RFID transponders and an interrogator unit are used for example in portable identification devices such as passive entry and immobilizer keys for vehicles. In this case, the interrogator unit is usually placed in the vehicle and the transponder is carried by the driver in form of a tag or a chip card. Typically, these RFID systems operate at a frequency in a low frequency (LF) range around 125 kilohertz or 134 kilohertz.

Active transponders are battery powered, whereas passive transponders have no autonomous power supply. Instead, they use RF energy received with an LC resonant circuit from the interrogator unit during an interrogation interval by rectifying the received RF signal and charging a storage capacitor with the rectified signal. Combined systems are known where a battery is provided as a backup solution, in case that the charged power is insufficient.

Passive transponders are usually realized as half-duplex (HDX) transponders. A HDX transponder receives, in a first time, an interrogation RF signal. The end of the interrogation interval is detected by an end-of-burst (EOB) detector. The interrogation interval is followed by a response interval during which the transponder is expected to send some response (i.e., ID code or some other data). Energy for operating the transponder when sending the response during the response interval is supplied by the storage capacitor.

Transponders with only one antenna are sensitive to orientation. Therefore, advanced transponders are provided with three antennas in the form of three LC resonant circuits which are arranged in a three-dimensional configuration. The three antenna circuits have antenna structures that are physically oriented at mutually 90 degrees. With such a transponder, signals from a transceiver/interrogator placed for example in a vehicle are detected independently of orientation in space of the transponder.

While it is an advantage to have three LC resonant circuits, this means that three receiver channels are needed. On the other hand, it is important that power consumption of the transponder during charging the storage capacitor must be as low as possible.

### SUMMARY OF THE INVENTION

It is a general object of the invention to provide an integrated three-dimensional front-end circuit for RFID transponders. A channel selector is provided, which is adapted to detect which one of the storage capacitors is first charged to a threshold voltage and which is further adapted to select the receiver channel associated to the first charged storage capacitor and to deactivate the two other receiver channels. Obviously, the storage capacitor which is first charged to the threshold voltage, will be the storage capacitor which is associated to the LC resonant circuit which is oriented in the best way to receive the charging RF signal from the interrogator unit. Thus, it is the receiver channel which receives the interrogation signal best which is selected. This channel is also best suited for transmitting a response. By deactivating the other two receiver channels, no energy is needed for these receiver channels.

In an embodiment, the storage capacitors of the two deactivated receiver channels are discharged and the RF signals of the two deactivated receiver channels are damped. Thus, they do not interfere with the signals and voltages of the selected receiver channel.

In one aspect, each storage capacitor is connected with a first terminal to the associated LC resonant circuit and with a second terminal to ground and the channel selector further comprises three field effect transistors (FET), one associated to each receiver channel. The drain of each FET transistor is connected to the first terminal of the associated storage capacitor, the source of each FET transistor is connected to ground and the gate of each FET transistor is connected decoupled to the first terminals of the two other storage capacitors of the two other receiver channels.

Thus, the voltage stored in each storage capacitor is applied to the gates of the two field effect transistors associated to the two other receiver channels. When the gate-source voltage reaches the threshold for switching the FET transistor, the FET transistor will connect the first terminal of the associated storage capacitor to ground and thus discharge the storage capacitor. As the storage capacitor of each receiver channel is connected to the FET transistors of the two other receiver channels, the storage capacitor which reaches the threshold first, will discharge the two other storage capacitors and deactivate the other two receiver channels.

In a further embodiment, the integrated three-dimensional front-end circuit comprises a single end-of-burst (EOB) detector. The input of the EOB detector is connectable decoupled to all three receiver channels and is automatically connected to the selected receiver channel whose storage capacitor is first charged to the threshold voltage. Thus, there is no need to have three end-of-burst detectors, one for each receiver channel, a single end-of-burst detector may be used for all three receiver channels.

In one aspect, the EOB detector comprises an output and each receiver channel comprises a clock regenerator with a first input connected to the first terminal of the associated storage capacitor and a second input of each clock regenerator connected to the output of the end-of-burst detector. The clock regenerator is used in connection with an oscillation maintenance circuit to provide the frequency necessary to send the response signal. When the EOB detector detects the end of a burst (i.e. the end of an interrogation interval), an output signal of the EOB detector will be applied to each clock regenerator. But only the clock regenerator which is associated to the selected receiver channel will receive at its first input a supply voltage, as the deactivated receiver channels have their associated storage capacitors discharged. Thus, only one clock regenerator will start working when receiving the end-of-burst signal. The oscillation maintenance circuit can be shared by the three channels.

In a further embodiment, the front-end circuit comprises an asymmetrical input stage. In this case, the three storage capacitors are preferably external to the front-end circuit and the front-end circuit is adapted to be connected to the three external storage capacitors.

In another embodiment, the front-end circuit comprises a symmetrical input stage. In this case, the three storage capacitors may be integrated in the front-end circuit. Preferably, the transponder further comprises a fourth storage capacitor and the front-end circuit is adapted to be connected to the fourth storage capacitor, which is connectable in parallel to all three integrated storage capacitors and which is connected automatically to the storage capacitor which is first charged to the threshold voltage. Thus, the three integrated storage capacitors can be made smaller because they are only charged up to the threshold voltage and then further charging is effectuated on the external fourth storage capacitor. An advantage of this embodiment is that only one external storage capacitor is needed.

An aspect of the invention further provides a method of operating a half-duplex RFID transponder with three LC resonant circuits arranged in a three-dimensional configuration according to claim 9, each LC resonant circuit being coupled to a different one of three storage capacitors which are charged during a capacitor charging phase by energy comprised in an RF signal received by the associated LC resonant circuit, and with three receiver channels associated to the three LC resonant circuits. The method comprises the steps of monitoring the charge level of each of the three storage capacitors and of detecting which storage capacitor is first charged to a threshold voltage. The method further comprises selecting the receiver channel associated to the first charged storage capacitor and deactivating the two other receiver channels.

### BRIEF DESCRIPTION OF DRAWINGS

Further aspects of the invention will ensue from the description herein below of preferred embodiments of the invention with reference to the accompanying drawings, wherein:

FIG. 1 is a schematic block diagram showing an example of an RFID system comprising an inventive front-end circuit;

FIG. 2 is a schematic of a first embodiment of a front-end circuit;

FIG. 3 is a schematic of a second embodiment with a symmetrical front-end circuit.

### DESCRIPTION OF THE EMBODIMENTS

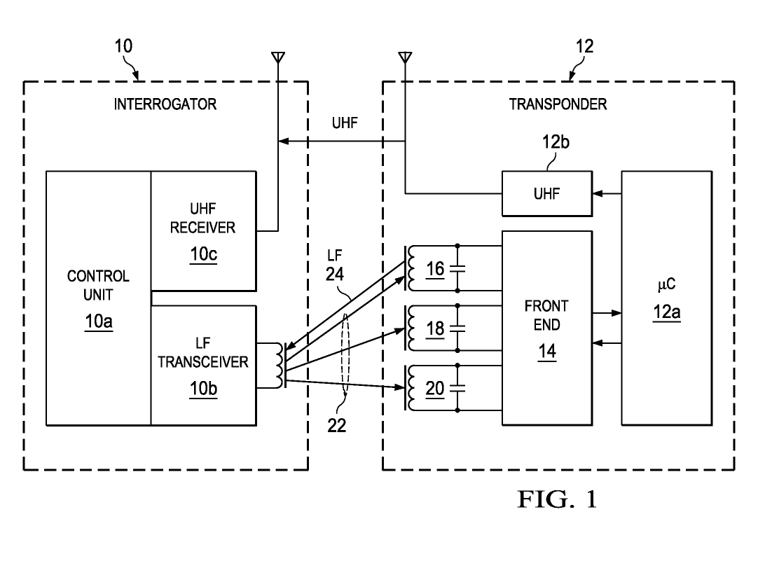

FIG. 1 shows an RFID system comprising an interrogator 10 which in the case of a passive entry system may be located in a vehicle. The interrogator comprises for example a control unit 10a, an LF transceiver 10b and a UHF receiver 10c. The RFID system further comprises an identification device or key or transponder 12 comprising for example a microcontroller or control logic 12a and probably additionally a UHF unit 12b for sending a UHF signal, and a front-end circuit 14 according to the invention connected to three LC resonant circuits 16, 18 and 20, which are arranged in a three-dimensional configuration. Arrows 22 indicate that the LF transceiver 10b will send an interrogation signal to all three LC resonant circuits during an interrogation interval. The interrogation interval is at the same time a capacitor charging phase, as at least one storage capacitor comprised in the transponder will be charged to supply the transponder with energy during the response interval. According to the orientation in space of transponder 12 in relation to interrogator unit 10, one LC resonant circuit will receive the interrogation signal best and the associated receiver channel will be selected. Only the LC resonant circuit which is associated to the selected receiver channel will send a response signal. In FIG. 1 this is LC resonant circuit 16 and the response signal is indicated by an arrow 24. Although FIG. 1 shows both directions for signal transmission, it is to be understood that in a half-duplex transponder receiving and transmitting are separated in time, transponder 12 first receives an interrogator signal 22 and afterwards sends a response 24.

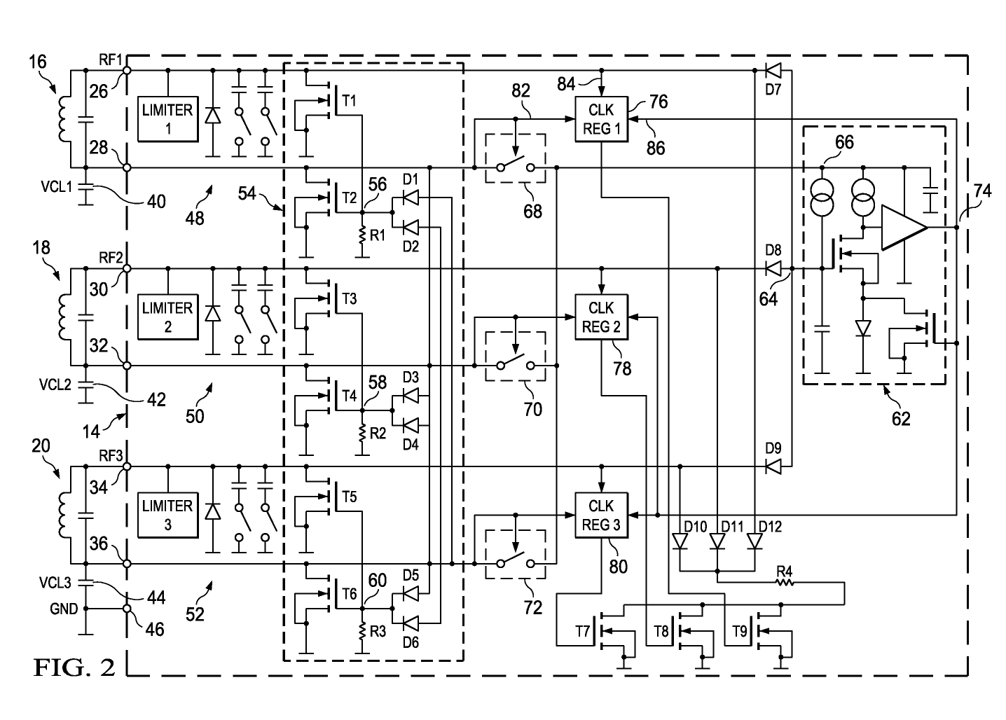

FIG. 2 shows the schematic of an embodiment of an inventive front-end circuit 14 comprising three asymmetrical input stages. Front-end circuit 14 is realized by a CMOS integrated circuit, the limits of which are visualized by a dashed line. Three LC resonant circuits 16, 18 and 20 are connected to input terminals 26, 28, 30, 32, 34 and 36 of the integrated front-end circuit 14. External to front-end circuit 14 are storage capacitors 40, 42 and 44. Storage capacitor 40 is associated to LC resonant circuit 16 and connected with a first terminal to input terminal 28 and thus to LC resonant circuit 16 and with a second terminal to ground. Storage capacitor 42 is associated to LC resonant circuit 18 and connected with a first terminal to input terminal 32 and thus to LC resonant circuit 18 and with a second terminal to ground. Storage capacitor 44 is associated to LC resonant circuit 20 and connected with a first terminal to input terminal 36 and thus to LC resonant circuit 20 and with a second terminal to ground. A further terminal 46 of the integrated front-end circuit 14 is also connected to ground.

Now components comprised in the integrated front-end circuit 14 will be described.

An asymmetrical input stage 48 is connected to input terminals 26 and 28, an asymmetrical input stage 50 is connected to input terminals 30 and 32, and an asymmetrical input stage 52 is connected to input terminals 34 and 36, each input stage 48, 50 and 52 comprising a limiter, a rectifying diode and two switchable capacitors as known in the state of the art.

The outputs of input stages 48, 50 and 52 are connected to a channel selector 54 comprising six field effect transistors T1, T2, . . . , T6, three resistors R1, R2 and R3 and six diodes D1, D2, . . . , D6. In the embodiment shown, transistors T1, T2, . . . , T6 are N channel transistors with their bulk connected to ground, but the person skilled in the art may adapt the circuitry for using other transistors as well.

Transistor T1 is connected with its drain to input terminal 26 and with its source to ground. Transistor T2 is connected with its drain to input terminal 28 and thus to the first terminal of storage capacitor 40 and with its source to ground. The gates of transistors T1 and T2 are connected to an interconnecting node 56 which is connected via resistor R1 to ground. Interconnecting node 56 is further connected to the cathode of diode D1 and to the cathode of diode D2. The anode of diode D1 is connected to input terminal 36 and thus to the first terminal of storage capacitor 44. The anode of diode D2 is connected to input terminal 32 and thus to the first terminal of storage capacitor 42. In this way, the gates of transistors T1 and T2 are connected decoupled by diodes D1 and D2 to the first terminals of storage capacitors 42 and 44.

Transistor T3 is connected with its drain to input terminal 30 and with its source to ground. Transistor T4 is connected with its drain to input terminal 32 and thus to the first terminal of storage capacitor 42 and with its source to ground. The gates of transistors T3 and T4 are connected to an interconnecting node 58 which is connected via resistor R2 to ground. Interconnecting node 58 is further connected to the cathode of diode D3 and to the cathode of diode D4. The anode of diode D3 is connected to input terminal 28 and thus to the first terminal of storage capacitor 40. The anode of diode D4 is connected to input terminal 36 and thus to the first terminal of storage capacitor 44.

Transistor T5 is connected with its drain to input terminal 34 and with its source to ground. Transistor T6 is connected with its drain to input terminal 36 and thus to the first terminal of storage capacitor 44 and with its source to ground. The gates of transistors T5 and T6 are connected to an interconnecting node 60 which is connected via resistor R3 to ground. Interconnecting node 60 is further connected to the cathode of diode D5 and to the cathode of diode D6. The anode of diode D5 is connected to input terminal 28 and thus to the first terminal of storage capacitor 40. The anode of diode D6 is connected to input terminal 32 and thus to the first terminal of storage capacitor 42.

The integrated front-end circuit 14 further comprises a common end-of-burst detector 62. End-of-burst detectors as such are already known in the state of the art and will not be explained in detail. End-of-burst detector 62 comprises a first input 64 which is connected to the anode of a diode D7, to the anode of a diode D8 and to the anode of a diode D9. The cathode of diode D7 is connected to input terminal 26, the cathode of diode D8 is connected to input terminal 30 and the cathode of diode D9 is connected to input terminal 34.

End-of-burst detector 62 has an input 64 which is via diodes D7, D8 and D9 or -wired to all RF-inputs, i.e. input terminals 26, 30 and 34, and comprises a second or supply voltage input 66 which is connected in parallel to input terminals 28, 32 and 36 and thus to all three storage capacitors 40, 42 and 44 via switches 68, 70 and 72. Switches 68, 70 and 72 are controlled by the voltage stored in the respective storage capacitors 40, 42 and 44. Switches 68, 70 and 72 may be realized by FET transistors.

End-of-burst detector 62 further comprises an output 74.

The integrated front-end circuit 14 further comprises three clock regenerator circuits 76, 78 and 80. Each clock regenerator comprises three inputs and one output. Clock regenerator 76 is connected with a first input 82 to input terminal 28, with a second input 84 to input terminal 26 and with a third input 86 to the output 74 of end-of-burst detector 62. Clock regenerator 78 is connected with a first input to input terminal 32, with a second input to input terminal 30 and with a third input to the output 74 of end-of-burst detector 62. Clock regenerator 80 is connected with a first input to input terminal 36, with a second input to input terminal 34 and with a third input to the output 74 of end-of-burst detector 62.

The three clock regenerator circuits 76, 78 and 80 are part of an oscillation maintenance circuit which further comprises three diodes D10, D11 and D12, a resistor R4 and three transistors T7, T8 and T9.

The output of clock regenerator 76 is connected to the gate of transistor T9, the output of clock regenerator 78 is connected to the gate of transistor T8 and the output of clock regenerator 80 is connected to the gate of transistor T7. Transistors T7, T8 and T9 have their sources connected to ground and their drains connected to a first terminal of resistor R4. A second terminal of resistor R4 is connected to the cathodes of diodes D10, D11 and D12. The anode of diode D10 is connected to input terminal 34, the anode of diode D11 is connected to input terminal 30 and the anode of diode D12 is connected to input terminal 26.

Input stage 48 forms together with clock regenerator 76 a first receiver channel associated to the LC resonant circuit 16 and the storage capacitor 40, input stage 50 forms together with clock regenerator 78 a second receiver channel associated to LC resonant circuit 18 and storage capacitor 42, and input stage 52 forms together with clock regenerator 80 a third receiver channel associated to LC resonant circuit 20 and storage capacitor 44.

In operation, interrogator 10 will send an interrogation signal 22 which is received by all three LC resonant circuits 16, 18 and 20. As the LC resonant circuits 16, 18 and 20 are arranged in a three-dimensional configuration, they will receive the interrogation signal 22 in different strength.

The RF signal received by each LC resonant circuit 16, 18 and 20 is rectified by a diode in the respective input stage and stored in the associated storage capacitors 40, 42 and 44. The LC resonant circuit which is spatially best adapted to receive the interrogation signal 22 will have its capacitor charged faster than the other LC resonant circuits.

The storage capacitor 40, 42 or 44 which will first be charged to a threshold voltage VTH will deactivate via channel selector 54 the other two receiver channels.

The function of channel selector 54 will be explained based on an example in which LC resonant circuit 16 is best adapted to receive interrogation signal 22, i.e. the first receiver channel comprising input stage 48 and clock regenerator 76 will be selected and deactivate the second and third receiver channels.

Thus, voltage VCL1 on storage capacitor 40 reaches first the threshold voltage VTH which is defined by the gate-source voltage of transistors T1 to T6 of channel selector 54 at which the transistors switch. Voltage VCL1 is applied via diode D3 to the gates of transistors T3 and T4 and via diode D5 to the gates of transistors T5 and T6. When threshold voltage VTH is reached, the drain-source channels of transistors T4 and T6 become conductive and shortcut storage capacitors 42 and 44 which in consequence are discharged. In the same way, the drain-source channels of transistors T3 and T5 become conductive and damp the RF signal received by the second and the third receiver channels. Therefore, the second and the third receiver channels are deactivated.

Capacitor 40 will continue to be charged during the interrogation interval.

With a voltage VCL1 greater or equal to threshold voltage VTH switch 68 will be closed and thus, voltage VCL1 is applied to supply input 66 of end-of-burst detector 62. In contrast, switches 70 and 72 will remain open because voltages VCL2 and VCL3 will never reach threshold voltage VTH as the capacitors 42 and 44 are discharged before.

When the interrogation interval is finished, the end-of-burst detector 62 will output an end-of-burst signal at its output 74.

Clock regenerator 76 then receives at its first input 82 as supply voltage voltage VCL1 which is greater than threshold voltage VTH, at its second input 84 the RF signal RF1 and at its third input the end-of-burst signal from end-of-burst detector 62. In contrast, clock regenerators 78 and 80 will not receive at their respective first inputs a supply voltage, as capacitors 42 and 44 are discharged via transistors T4 and T6. Nor will they receive at their respective second inputs an RF signal, because RF signals RF2 and RF3 are damped by transistors T3 and T5.

The interrogation interval is followed by a response interval, in which the energy stored during the interrogation interval is used. For sending the response oscillating of the selected LC resonant circuit 16 must be maintained.

Oscillation maintenance circuits are known in the state of the art. The kind of oscillation maintenance circuit used in the preferred embodiment is explained in German Patent Publication No. DE 10 2006 035 582 A1, published Feb. 7, 2008. Other kinds of oscillation maintenance circuit may be used.

For maintaining oscillation, clock regenerator 76 will output a clock signal to the gate of transistor T9 which will tic the corresponding RF input 26 to ground through current limiting transistor R4 during each negative half-wave of the RF signal. Thus, the oscillation signal of the selected LC resonant circuit 16 is sustained and remains at a constant amplitude.

Thus, although a three-dimensional front-end is provided, the energy needed is limited because only one of the three channels needs maintenance of oscillation.

Operation of the transponder has been explained based on the example that capacitor 40 is charged first. In the same way, the voltages VCL2 and VCL3 on storage capacitors 42 and 44 will lead to a deactivation of the respective two other receiver channels when they reach threshold voltage VTH first.

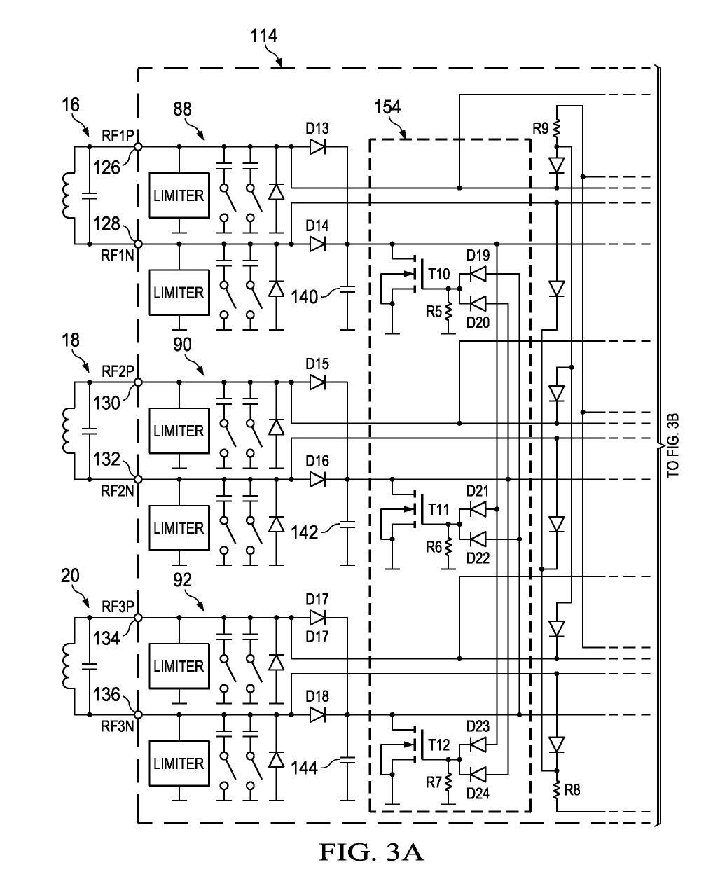

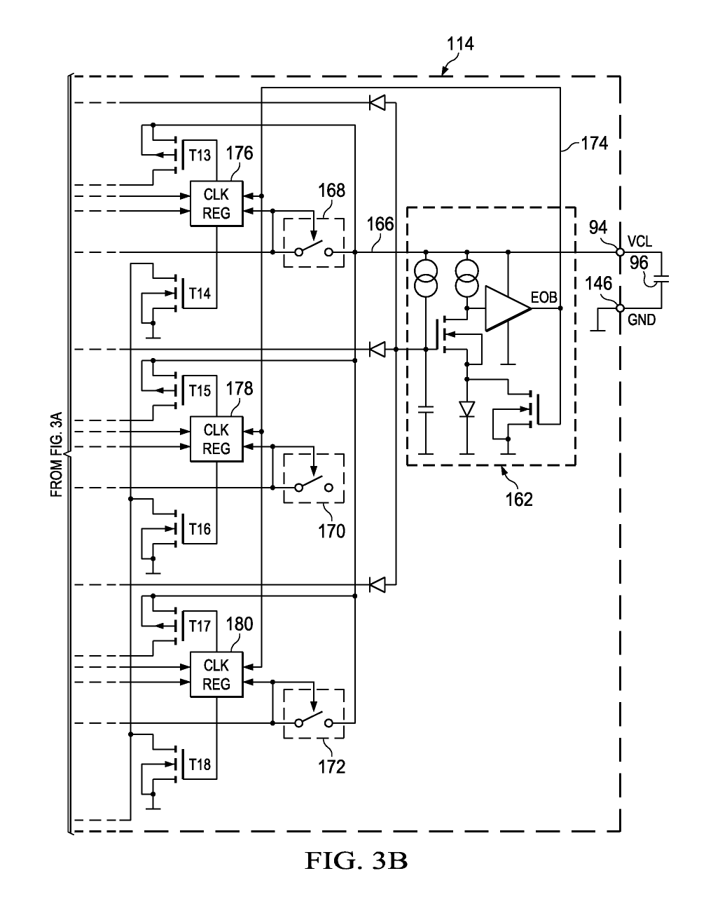

FIG. 3 shows the schematic of an embodiment of an inventive front-end circuit 114 with three symmetrical input stages. To facilitate understanding of this second embodiment compared to the first embodiment, the reference signs are increased by 100 for designating components which have the same function as in the asymmetrical embodiment.

The three LC resonant circuits 16, 18 and 20 are connected to input terminals 126, 128, 130, 132, 134 and 136 of the integrated front-end circuit 114.

A symmetrical input stage 88 is connected to input terminals 126 and 128, a symmetrical input stage 90 is connected to input terminals 130 and 132, and a symmetrical input stage 92 is connected to input terminals 134 and 136, each input stage 88, 90 and 92 comprises for each input terminal a limiter, a rectifying diode and two switchable capacitors.

A storage capacitor 140 is associated to LC resonant circuit 16 and connected with a first terminal to the cathode of a diode D13 and to the cathode of a diode D14 and with a second terminal to ground. The anode of diode D13 is connected to input terminal 126 and the anode of diode D14 is connected to input terminal 128. A storage capacitor 142 is associated to LC resonant circuit 18 and connected with a first terminal to the cathode of a diode D15 and to the cathode of a diode D16 and with a second terminal to ground. The anode of diode D15 is connected to input terminal 130 and the anode of diode D16 is connected to input terminal 132. A storage capacitor 144 is associated to LC resonant circuit 20 and connected with a first terminal to the cathode of a diode D17 and to the cathode of a diode D18 and with a second terminal to ground. The anode of diode D17 is connected to input terminal 134 and the anode of diode D18 is connected to input terminal 136.

The storage capacitors 140, 142 and 144 are integrated on the front-end circuit 114. They are charged via diodes D13, D14, . . . , D18 from the energy received on the two input terminals connected to LC resonant circuits 16, 18 and 20.

The front-end circuit 114 further comprises a channel selector 154, an oscillation maintenance circuit and a common end-of-burst detector 162.

The channel selector 154 comprises three field effect transistors T10, T11 and T12, three resistors R5, R6 and R7 and six diodes D19, D20, . . . , D24. The interconnection between the components of channel selector 154 and its function is the same as for channel selector 54 of the embodiment shown in FIG. 2 and will not be explained any further. Transistors T10, T11 and T12 correspond to transistors T2, T4 and T6 and at the same time to transistors T1, T3 and T5, they discharge the storage capacitors 140, 142 and 144 associated to the deactivated channels and damp the RF signals received by the deactivated channels.

As in the embodiment shown in FIG. 2, the oscillation maintenance circuit comprises three clock regenerators 176, 178 and 180. The oscillation maintenance circuit further comprises six transistors T13, T14, . . . , T18, two resistors R8 and R9 and six diodes. The clock regenerators have four inputs each as there are two RF signals input because of the symmetrical input stages 88, 90 and 92. The further two inputs are connected as in the first embodiment to an output 174 of the end-of-burst detector 162 and to the first terminal of the associated storage capacitor.

Clock regenerators 176, 178 and 180 further comprise two outputs each. A first output of clock regenerator 176 is connected to the gate of transistor T13 and a second output of clock regenerator 176 is connected to the gate of transistor T14. A first output of clock regenerator 178 is connected to the gate of transistor T15 and a second output of clock regenerator 178 is connected to the gate of transistor T16. A first output of clock regenerator 180 is connected to the gate of transistor T17 and a second output of clock regenerator 180 is connected to the gate of transistor T18.

Transistors T14, T16 and T18 have their sources connected to ground and their drains connected to a first terminal of resistor R8, whereas transistors T13, T15 and T17 have their drains connected to a first terminal of resistor R9. A second terminal of resistor R8 is connected via diodes to input terminals 128, 132 and 136. A second terminal of resistor R9 is connected via diodes to input terminals 126, 130 and 134.

The function of the oscillation maintenance circuit of front-end 114 corresponds to the function of oscillation maintenance circuit of front-end 14 and will not be explained further.

End-of-burst detector 162 comprises a supply voltage input 166 which is connected in parallel to the first terminals of storage capacitors 140, 142 and 144 via switches 168, 170 and 172. Supply voltage input 166 is further connected to an input terminal 94. An external storage capacitor 96 is connected with a first terminal to input terminal 94 and with a second terminal via a terminal 146 of the integrated front-end circuit 114 to ground.

In operation, channel selector 154 will detect during an interrogation interval as explained for the first embodiment which one of storage capacitors 140, 142 and 144 will reach the threshold voltage VTH first, select the corresponding receiving channel and deactivate the other receiving channels. As in the embodiment shown in FIG. 2, switches 168, 170 or 172 are controlled by the voltage stored on the storage capacitors 140, 142 and 144. The corresponding switch 168, 170 or 172 will be closed and connect the supply voltage input 166 of end-of-burst detector 162 to the charged storage capacitor. At the same time, external storage capacitor 96 will be connected in parallel to the selected storage capacitor and thus will be charged as well by the energy comprised in the interrogation RF signal. Therefore, storage capacitors 140, 142 and 144 can be dimensioned smaller than the external capacitors 40, 42 and 44 as they must only be sufficiently large for being charged up to the threshold voltage VTH. After reaching the threshold voltage, external storage capacitor 96 is connected in parallel and is charged as well.

Although the present invention has been described in detail, it should be understood that various changes, substitutions and alterations can be made hereto without departing from the spirit and scope of the invention as defined by the appended claims.

1. A half-duplex RFID transponder with an integrated three-dimensional front-end circuit, the RFID transponder comprising three LC resonant circuits arranged in a three-dimensional configuration, each LC resonant circuit being coupled to a different one of three storage capacitors which are charged during a capacitor charging phase by energy comprised in an RF signal received by the associated LC resonant circuit,
the front-end circuit comprising:
three receiver channels, each receiver channel being associated to a different one of the three LC resonant circuits;
a channel selector which is adapted to detect, which one of the three storage capacitors is first charged to a threshold voltage,
to select the receiver channel associated to the LC resonant circuit which is coupled to the storage capacitor which is first charged, and
to deactivate the two other receiver channels.

2. The transponder according to claim 1, wherein the storage capacitors of the two deactivated receiver channels are discharged and the RF signals received by the two deactivated receiver channels are damped.

3. The transponder according to claim 1, wherein each storage capacitor is connected with a first terminal to the associated LC resonant circuit and with a second terminal to ground, the channel selector comprising:
three FET transistors, one associated to each of the receiver channels, wherein the drain of each FET transistor is connected to the first terminal of the associated storage capacitor, the source of each FET transistor is connected to ground and the gate of each FET transistor is connected decoupled to the first terminals of the two other storage capacitors of the two other receiver channels.

4. The transponder according to claim 1, the front-end circuit further comprises:
a single end-of-burst detector a supply input of which is connectable decoupled to all three storage capacitors and is connected automatically to the storage capacitor which is first charged to the threshold voltage.

5. The transponder according to claim 4, wherein the single end-of-burst detector comprises an output and each receiver channel comprises a clock regenerator with a first input connected to the first terminal of the associated storage capacitor and a second input of each clock regenerator connected to the output of the end-of-burst detector.

6. The transponder according to claim 1, having an asymmetrical input stage, the three storage capacitors being external to the front-end circuit and the front-end circuit being adapted to be connected to the three storage capacitors.

7. The transponder according to claim 6, wherein the channel selector comprises three further FET transistors, one associated to each of the receiver channels, wherein the drain of each FET transistor is connected to the associated LC resonant circuit, the source of each FET transistor is connected to ground and the gate of each FET transistor is connected to the first terminals of the two other storage capacitors of the two other receiver channels.

8. The transponder according to claim 1, having a symmetrical input stage, wherein the three storage capacitors are integrated in the circuit and the front-end circuit being further adapted to be connected to a fourth storage capacitor which is connectable in parallel to all three integrated storage capacitors and which is connected automatically to the storage capacitor which is first charged to the threshold voltage.

9. The transponder according to claim 2, wherein each storage capacitor is connected with a first terminal to the associated LC resonant circuit and with a second terminal to ground, the channel selector comprising:
three FET transistors, one associated to each of the receiver channels, wherein the drain of each FET transistor is connected to the first terminal of the associated storage capacitor, the source of each FET transistor is connected to ground and the gate of each FET transistor is connected decoupled to the first terminals of the two other storage capacitors of the two other receiver channels.

10. The transponder according to claim 2, the front-end circuit further comprises:
a single end-of-burst detector a supply input of which is connectable decoupled to all three storage capacitors and is connected automatically to the storage capacitor which is first charged to the threshold voltage.

11. The transponder according to claim 3, the front-end circuit further comprises:
a single end-of-burst detector a supply input of which is connectable decoupled to all three storage capacitors and is connected automatically to the storage capacitor which is first charged to the threshold voltage.

12. The transponder according to claim 2, having an asymmetrical input stage, the three storage capacitors being external to the front-end circuit and the front-end circuit being adapted to be connected to the three storage capacitors.

13. The transponder according to claim 3, having an asymmetrical input stage, the three storage capacitors being external to the front-end circuit and the front-end circuit being adapted to be connected to the three storage capacitors.

14. The transponder according to claim 4, having an asymmetrical input stage, the three storage capacitors being external to the front-end circuit and the front-end circuit being adapted to be connected to the three storage capacitors.

15. The transponder according to claim 5, having an asymmetrical input stage, the three storage capacitors being external to the front-end circuit and the front-end circuit being adapted to be connected to the three storage capacitors.

16. The transponder according to claim 2, having a symmetrical input stage, wherein the three storage capacitors are integrated in the circuit and the front-end circuit being further adapted to be connected to a fourth storage capacitor which is connectable in parallel to all three integrated storage capacitors and which is connected automatically to the storage capacitor which is first charged to the threshold voltage.

17. The transponder according to claim 3, having a symmetrical input stage, wherein the three storage capacitors are integrated in the circuit and the front-end circuit being further adapted to be connected to a fourth storage capacitor which is connectable in parallel to all three integrated storage capacitors and which is connected automatically to the storage capacitor which is first charged to the threshold voltage.

18. The transponder according to claim 4, having a symmetrical input stage, wherein the three storage capacitors are integrated in the circuit and the front-end circuit being further adapted to be connected to a fourth storage capacitor which is connectable in parallel to all three integrated storage capacitors and which is connected automatically to the storage capacitor which is first charged to the threshold voltage.

19. The transponder according to claim 5, having a symmetrical input stage, wherein the three storage capacitors are integrated in the circuit and the front-end circuit being further adapted to be connected to a fourth storage capacitor which is connectable in parallel to all three integrated storage capacitors and which is connected automatically to the storage capacitor which is first charged to the threshold voltage.

20. A method of operating a half-duplex RFID transponder with three LC resonant circuits arranged in a three-dimensional configuration, each LC resonant circuit being coupled to a different one of three storage capacitors which are charged during a capacitor charging phase by energy comprised in an RF signal received by the associated LC resonant circuit, and with three receiver channels associated to the three LC resonant circuits, the method comprising:
monitoring the charge level of each of the three storage capacitors;
detecting which storage capacitor is first charged to a threshold voltage;
selecting the receiver channel associated to the LC resonant circuit which is coupled to the storage capacitor which is first charged; and
deactivating the two other receiver channels.
